(19) United States
(12) Patent Application Publication
(10) Pub. No.: US 2007/0076301 A1
(43) Pub. Date: Apr. 5, 2007

(54) Process for coloring a lens by spin coating and the colored lens obtained by this process

(75) Inventors: Jorge Couto, rue de Paris (FR); Francis Henky, rue de Paris (FR); David Robin, rue de Paris (FR)

Correspondence Address: FISH & RICHARDSON PC, P.O. BOX 1022, MINNEAPOLIS, MN, 55440-1022, US

(73) Assignee: ESSILOR INTERNATIONAL (COMPAGNIE GENERALE D'OPTIQUE)

(21) Appl. No.: 11/542,618

(22) Filed: Oct. 3, 2006

(30) Foreign Application Priority Data
Oct. 4, 2005 (FR) 05 10143

(51) Int. Cl. B29D 11/00; G02B 1/10

(52) U.S. Cl. 359/642; 359/581; 359/900; 264/1.32

(57) ABSTRACT

Process for coloring an optical lens by spin coating which comprises (i) increasing or decreasing the temperature of at least one zone of the lens surface by at least 2° C. by any suitable means and (ii) simultaneously, or successively, depositing a colored coating comprising a volatile solvent over the entire surface of the lens by spin coating. The subject of the invention is also a method of controlling the thickness of a coating, deposited by spin coating over the whole lens, and a colored lens obtained by the coloring process of the invention.

This invention relates to the field of coloring optical lenses, especially ophthalmic lenses, and more especially to the design of colored patterns or color gradients on the lenses. The invention also relates to the spin-coating technique and to its use for the production of colored lenses.

The invention actually relates to a process for coloring by spin coating optical lenses, especially ophthalmic lenses, which may be corrective or not, and which may offer a sun protection or not.

The lenses of the present invention are obtainable by using various substrates of different kinds, for example by using organic glass substrates such as diethylene glycol bis(allyl carbonate) better known as CR39, or by using polycarbonate substrate.

In the present invention, the term optical refers to ophthalmic optics, photographic optics and instrumentation optics.

Various methods for obtaining color gradients on ophthalmic substrates, such as for example CR39 or polycarbonate, are known from the prior art. For example, the coloring technique by dipping a substrate in a coloring dip is well known. There are also a number of publications on the application of colored coatings by ink-jet printing.

Similarly, various methods for obtaining colored patterns are known. For example, to produce a colored pattern on a substrate, the pattern may be painted or printed by means of various techniques such as for example pad printing, that is very much used in applying patterns onto optical glass.

Other techniques, such as laser marking, that allow the coating layer to be blasted, are known and used to produce subtle marking with a differential in surface appearance.

In addition, those skilled in the art know how to use the spin-coating method to apply a coating; spin coating is a method that is quick and easy to implement, is reproducible and can be applied to any type of substrate, whatever material it is made from.

However, this method is used by those skilled in the art only to apply uniformly-thick coatings, which means coatings of equal thickness over the entire lens surface. In particular, those skilled in the art know how to apply a colored coating on a lens by spin coating, and know that using this technique will allow them to consistently obtain a uniform shade over the entire lens surface.

Thus, the spin-coating method as such does not a priori allow color gradients or colored designs to be produced on lenses. This is because, to obtain a color gradient or colored designs on lenses, it is necessary to apply at least one coating layer of variable thickness. The thicker the coating, the more intense the color is.

The technical problem of the invention is that of using spin coating to apply at least one coating layer of variable thickness, this coating preferably being colored.

The solution developed by the Applicant involves differential evaporation of the preferably colored coating, applied by spin coating to the substrate, depending on the lens temperature.

The coloring process of the invention has numerous advantages: it is independent from the type of substrate, it is reproducible and the color shade is easy to control as it depends on the temperature applied to the lens surface for a given coating and substrate.

Finally, the process of the invention is simpler and faster than the techniques of the prior art.

By this process, strong color intensity (dark shade) for distant vision and a weaker intensity (light shade) for near vision can be obtained.

The process of the invention can also be used to obtain colored patterns on a lens. Thus the application of a pad representing a specific design, for example, a logo, heated or cooled prior to being applied to the lens surface, allows the pattern embossed on the pad to be transferred by the difference in hue.

Thus the invention relates to a process for coloring lenses by spin coating which makes it possible to apply at least one coating layer of variable thickness, and therefore to obtain colored lenses by spin coating that may have a color gradient or a pattern.

More precisely, the invention provides a process for coloring lenses by spin coating, and especially a process for obtaining a color gradient or a colored design, the process being characterized in that it comprises the steps of:
a) increasing or decreasing the temperature by at least 2° C., preferably by at least 10° C., in at least one zone of the lens surface, more preferentially by 40 to 60° C., by any suitable means;
b) simultaneously, or successively, applying a coating, preferably colored, comprising a volatile solvent on the entire surface of the lens by spin coating.

The term “volatile” for the purpose of the present invention is understood as any solvent capable of evaporating under the effect of the temperature to which one zone of the lens is subjected. It is understood that the volatile nature of the solvent is directly related to its vapor pressure.

The term “zone” is understood as all or part of the surface of one face of the lens.

The suitable means of increasing or decreasing the temperature comprises conduction by a solid or a liquid or convection by a gas. This means especially comprises applying a cooled or heated pad to said zone, exposing said zone to UV or IR radiation or subjecting said zone to the action of a layer of hot or cooled air especially under nitrogen or bringing said zone into contact with a liquid that is heated or cooled with respect to room temperature. Preferably the liquid is heated to a temperature of 40-80° C., preferably about 70° C.

According to a first embodiment, the temperature increase or decrease of said zone is carried out prior to the coating step.

According to another embodiment, the temperature increase or decrease is carried out during the coating step.

Advantageously, the zone or zones where the temperature is increased or decreased is/are determined by means of a mask placed between the heat source and the lens surface, or by means of a relative movement of the lens with respect to the heat source. The form of the mask used or the relative movement carried out are dependent on the color gradient or colored patterns that are wished to be obtained on the lens.

According to a first embodiment of the invention, the heating or cooling zone is smaller than the area of one face of the lens.

In a preferred embodiment, a temperature gradient is set up over all or part of the lens surface so as to obtain a color gradient.

In another preferred embodiment, the temperature is increased or decreased over a fixed area delineating a pattern.

The colored coating according to the invention is preferably a dispersion of polymers such as sol-gels, poly(meth)acrylic latices, poly(meth)acrylic-styrene latices and polyurethane latices and organic pigments in a volatile solvent that is capable of evaporating more quickly under the effect of the increase in temperature of the lens. Among the solvents that can be used within the scope of the invention, mention may be made, by way of example, of water, N-methylpyrrilidone, alcohols, especially linear or branched alcohols having a C₁-C₆ alkyl chain, glycerol and its derivatives and ketones, such as linear or branched ketones having a C₁-C₆ alkyl chain, especially methyl ethyl ketone.

If the temperature of one zone of the lens surface is equal to or above the evaporation temperature of the solvent in the coating, the coating will evaporate. The higher the temperature of this zone, the faster the solvent evaporates, which leads to an increase in coating viscosity. As a consequence of the increase in coating viscosity, the thickness of the coating increases in this zone. As a result, the coating color in this zone is more intense (or darker) than in the other zones of the lens. This variation in the solvent evaporation rate (and therefore in the coating viscosity) is directly related to the vapour pressure of the solvent in the coating. Consequently it is understood that the pressure and the nature of the environment around the lens are parameters that, in addition to the temperature, are apt to have an influence on the thickness of the coating deposited on said lens.

The invention also relates to a colored lens able to be obtained by implementing the coloring process of the invention.

The lens substrate may be of any type. By way of non-limiting example, as a substrate which may be used within the scope of the invention, mention may be made of the substrates conventionally used in optics and ophthalmics. For example, substrates of the following type are suitable: polycarbonate; polyamide; polyimides; polysulphones; polyethylene terephthalate and polycarbonate copolymers; polyolefins, especially polynorbornenes; diethylene glycol bis(allyl carbonate) polymers and copolymers; (meth)acrylic polymers and copolymers, especially polymers and copolymers of (meth)acrylic derivatives of bisphenol A; thio(meth)acrylic polymers and copolymers; urethane and polyurethane polymers and copolymers; epoxy polymers and copolymers and episulphide polymers and copolymers.

Said lens is preferably an ophthalmic lens made of CR39 or polycarbonate.

A subject of the invention is also a method of controlling the thickness of a coating deposited by spin coating on a substrate, one zone of which is heated or cooled so that the coating evaporates from at least one point on the lens surface. Advantageously, this control comprises checking and controlling the temperature variation of the lens surface on which the coating is deposited. Preferably the control method also takes into account the pressure and the nature of the environment around the lens.

Other advantages and features of the invention will become apparent from the non-limiting examples that are given.

### EXAMPLES

Lenses were colored using the process of the invention. The lens substrates used in this example were ORMA (a diethylene glycol bis(allyl carbonate) polymer) and CR39, which is sold by PPG. The thickness of these substrates at the center was less than 3 mm. The substrates were heated by immersing them in a water bath at 70° C. The coloring coatings deposited on the substrates were: W234 sold by Baxenden, prepared according to the protocol described in Patent U.S. Pat. No. 5 316 791 and comprising a mixture of pigments of four colors, blue, yellow, red and black, these pigments being for example sold by Clariant and by Toyo.

The thickness of the coating deposited on the substrate was measured, at predetermined points in a cold zone and in a hot zone, as a function of the exposure time to an infrared lamp. The term “cold zone” is understood to mean the zone of the lens that was not subjected to the IR radiation. The term “hot zone” is understood to mean the zone of said lens that was subjected to said IR radiation.

The results are given in the Table below:

| | | Thickness in the | |
|---|---|---|---|
| Exposure time | Thickness in the “cold” | “hot” (˜70° C.) zone | |
| (seconds) | (˜23° C.) zone (μm) | (μm) | Δ |
| 0 | 3.97 | 3.99 | 0.02 |
| 10 | 4.47 | 6.21 | 1.74 |
| 20 | 4.6 | 7.09 | 2.49 |
| 30 | 4.5 | 7.37 | 2.87 |
| 40 | 4.7 | 8.43 | 3.73 |
| 50 | 4.57 | 8.15 | 3.58 |
| 60 | 4.6 | 8.2 | 3.6 |
| 70 | 5.14 | 8.46 | 3.32 |
| 80 | 4.98 | 8.45 | 3.47 |

The measurements of the coating thickness on the substrate show variations in the thickness of up to 4 μm between the “cold” zone and the “hot” zone. It was observed that the hotter the lens, the greater the coating thickness increase, and the darker the shade obtained.

A plateau in the thickness of the coating was observed from 40 seconds onwards. This plateau corresponds to the time needed for the substrate to reach thermal equilibrium throughout. This time increases with the lens thickness and also with the source of heating or cooling used.

Measurements of the transmission factor (Tv) of several samples were carried out. The process according to the invention easily allows all the color grades (Class 1 to Class 4) conventionally used in the ophthalmics field to be obtained. Thus a deposit of a grey-colored latex on a lens by spin coating, at thicknesses of 4.43 μm, 6.00 μm and 8.45 μm, makes it possible to obtain Tv values of 25% (Class 2), 15% (Class 3) and 7.5% (Class 4) respectively.

The shade obtained for a specific temperature applied to the lens surface is dependent on several parameters that can be defined in advance, such as the type of substrate, its thermal conductivity, its thickness and the type of solvents used in the coloring coating.

1. Process for coloring a lens by spin coating, said process being characterized in that it comprises the steps of:
a) increasing or decreasing the temperature of at least one zone of the lens surface by at least 2° C., said zone being limited to one part of the surface of the lens, by any suitable means;
b) simultaneously, or successively, applying a colored coating comprising a volatile solvent over the entire surface of the lens by spin coating.

2. Coloring process according to claim 1, wherein the suitable means of increasing or decreasing the temperature comprises any means of conduction by a solid or a liquid, or convection by a gas.

3. Coloring process according to claim 1, wherein the suitable means of increasing or decreasing the temperature especially comprises applying a cooled or heated pad to said zone, exposing said zone to UV or IR radiation or subjecting said zone to the action of a layer of hot or cooled air or bringing said zone into contact with a liquid that is heated or cooled with respect to room temperature.

4. Coloring process according to claim 1, wherein the temperature increase or decrease is carried out prior to the coating step.

5. Coloring process according to claim 1, characterized in that the temperature increase or decrease is carried out during the coating step.

6. Coloring process according to claim 1, characterized in that the zone where the temperature is increased or decreased is determined by means of a mask placed between the heat source and the lens surface or by a relative movement of the lens with respect to the heat source.

7. Coloring process according to claim 1, wherein a temperature gradient is set up over all or part of the lens surface.

8. Coloring process according to claim 1, wherein the temperature is increased or decreased over a fixed area delineating a design.

9. Method of controlling the thickness of a coating having a volatile solvent, deposited by spin coating over the whole lens, especially by means of controlling the temperature variation of the lens surface on which the coating is deposited.

10. Colored lens obtainable by the process comprising the steps of:
c) increasing or decreasing the temperature of at least one zone of the lens surface by at least 2° C., said zone being limited to one part of the surface of the lens, by any suitable means;
d) simultaneously, or successively, applying a colored coating comprising a volatile solvent over the entire surface of the lens by spin coating.

11. Colored lens according to claim 10, wherein the suitable means of increasing or decreasing the temperature comprises any means of conduction by a solid or a liquid, or convection by a gas.

12. Colored lens according to claim 10, wherein the suitable means of increasing or decreasing the temperature especially comprises applying a cooled or heated pad to said zone, exposing said zone to UV or IR radiation or subjecting said zone to the action of a layer of hot or cooled air or bringing said zone into contact with a liquid that is heated or cooled with respect to room temperature.

13. Colored lens according to claim 10, wherein the temperature increase or decrease is carried out prior to the coating step.

14. Colored lens according to claim 10, wherein the temperature increase or decrease is carried out during the coating step.

15. Colored lens according to claim 10, wherein the zone where the temperature is increased or decreased is determined by means of a mask placed between the heat source and the lens surface or by a relative movement of the lens with respect to the heat source.

16. Colored lens according to claim 10, wherein a temperature gradient is set up over all or part of the lens surface.

17. Colored lens according to claim 10, wherein the temperature is increased or decreased over a fixed area delineating a design.
